(19) United States
(12) Patent Application Publication
(10) Pub. No.: US 2010/0107474 A1
(43) Pub. Date: May 6, 2010

(54) Apparatus and method for Rapid Biodiesel Fuel Production

(76) Inventors: Mahesh Talwar, Somis, CA (US); Jagroop S. Gill, Delta (CA); Angelo C. Piro, JR., Swedesboro, NE (US)

Correspondence Address: AVERILL & VARN, 8244 PAINTER AVE., WHITTIER, CA, 90602, US

(21) Appl. No.: 12/262,942

(22) Filed: Oct. 31, 2008

(51) Int. Cl. C10L 1/18; B01J 19/00

(52) U.S. Cl. 44/308; 422/190

(57) ABSTRACT

Apparatus and method for rapid production of biodiesel fuel. The apparatus includes a packed column followed by a high pressure kinetic reactor. A homogeneous stream of feed oil (vegetable oil or animal fat), methanol, and a catalyst is metered, mixed, fed into a packed column, and finally into the high pressure kinetic reactor where the conversion into biodiesel fuel is completed. The packed column is packed with rings (either Raschig rings or pall rings or equivalent). The homogeneous stream enters from the bottom with rings kept in a fluidized bed state to allow greatest surface area for reaction to take place. Approximately 40 to 70 percent reaction is typically achieved in the packed column. The high pressure kinetic reactor receives the partially reacted homogeneous stream and breaks fluid molecules into nano molecules with very high instantaneous temperatures and availability of large surface areas which allow complete reaction without external heat.

### BACKGROUND OF THE INVENTION

The present invention relates to the production of biodiesel fuel and in particular to rapid production of biodiesel fuel.

Recent increases in the cost of petroleum have raised both economic and national security concerns. Petroleum costs translate directly into gasoline and diesel fuel costs which impact both personal and commercial expenses. Various alternatives for powering vehicles have been proposed and in various stages of maturity. These alternatives including: natural gas; electricity; hydrogen; and biodiesel. Biodiesel is an alternative fuel for conventional diesel engines and offers advantages including less pollution, but presently is not available in large quantities.

Biodiesel is produced from ingredients comprising feed oils (vegetable oils or animal fats), a small percentage of alcohol, and a catalyst. The process for producing biodiesel fuel, commonly called transesterification, generally includes a tradeoff between reaction time and temperature, and involves the reaction of triglycerides in the feed oils with the alcohol to produce a mixture of methyl esters and glycerin. The production of biodiesel fuel in the US reached approximately 250 million gallons in 2006 compared to diesel fuel consumption of over 50 billion gallons a year in the US.

Conventional biodiesel production technology involves introducing the feed oil, methanol, and a catalyst into a two stage reactor vessel and requires up to two hours or more for completion of a chemical reaction converting the ingredients into biodiesel fuel and a glycerine byproduct. Many plants have incorporated multiple reactor systems to do continuous batch processing. High residence time in reactors requires very large reactor vessels, for example, a 20 gpm (10 million gallons/yr) plant will require total reactor vessel capacity of about 3,600 gallons which requires a large foot print. Additionally, high residence time promotes a secondary formation of soaps which are undesired contaminants and must be removed using an expensive wash technology to meet biodiesel fuel specifications. Soaps also trap product biodiesel with resulting yield loss of two to three percent. Soaps in the glycerine byproduct also make the glycerine less desirable because it requires acidulation and results in production of acid oils which have very low market value and often require disposal as a hazardous liquid waste.

IKA Corporation sells high shear reactors intended to address the time/heat issues of biodiesel fuel production. Reaction inside each high shear reactor is fast, only a few seconds; however, the IKA process requires two stage high shear pumps with intermediate holding tanks to complete the reaction. Holding tanks complete the reaction in about 15-20 minutes, and soap formation is not eliminated.

Arisdyne Systems and Hydro Dynamics, Inc. make hydrodynamic cavitations based reactors intended to address the time/heat issues of biodiesel production. While these reactors speed up the reaction, each facility requires a complex two stage reactor system to complete the reaction which increases complexity of the system and costs involved.

Thus, a need remains for rapid low cost fast production of biodiesel fuel.

### BRIEF SUMMARY OF THE INVENTION

The present invention addresses the above and other needs by providing a biodiesel fuel production system including a packed bed column followed by a high pressure kinetic reactor to achieve nearly complete production of biodiesel fuel while minimizing undesired by products. High surface area made available through packed bed columns provide 40 to 70 percent reaction completion in a first phase. The remaining reaction is completed in the high pressure kinetic reactor which is preferably a high pressure cavitation chamber. The present invention allows reactions to proceed at 40 degrees centigrade as opposed to 80 to 100 degrees centigrade required by known fast reactors, thus saving energy costs. Near stoichiometric quantities of methanol are sufficient for reaction completion in the present invention compared to 50 to 100 percent excess methanol required in known systems. The present invention allows all of the chemicals to be added ahead of the packed bed column as opposed to spilt chemicals being added in a conventional reactor system into first stage and then second stage. Known systems require a limit of Free Fatty Acid (FFA) content in the incoming feed oil to less than 2.5 percent, and required refined, bleached, degummed oil for feed. The present invention processes degummed crude palm oil with five to eight percent FFA with minimal soaps formation as well as tallow with 2.8% FFA with complete success. In known processes, FFA will react into soaps. The present invention does not produce such soaps.

In accordance with one aspect of the invention, there is provided a continuous flow through system for rapid production of biodiesel fuel. The continuous flow system includes flow meters and/or pumps, a venturi static mixer, packed bed columns for a first phase, and a high pressure kinetic reactor for completing the rapid production of the biodiesel fuel. Following metering, the ingredients are introduced into the venturi static mixer which allows thorough mixing of the ingredients into one homogeneous stream. The homogeneous stream then enters the packed bed column which is designed for three minutes residence time. The partially reacted ingredients then enter the high pressure kinetic reactor. Fluids exiting the high pressure kinetic reactor are completely reacted into biodiesel fuel and byproduct glycerine.

In accordance with yet another aspect of the invention, there is provided a packed bed column. The packed bed column is packed with rings (either Raschig rings or pall rings or the equivalent). The homogeneous stream enters from the bottom with rings kept in a fluidized bed state to allow greatest surface area for reaction to take place. Approximately 40-70% reaction is typically achieved in the packed bed column.

In accordance with yet another aspect of the invention, there is provided a kinetic reactor comprising a high pressure cavitation reactor based on principles of hydro cavitation and high shear whereby the cavitation forces break fluid molecules into nano molecules with very high instantaneous temperatures and availability of large surface areas which allow complete reaction without external heat. The high pressure kinetic reactor is operated at 700-1000 psi pressure and is composed of an adjustable need valve design in which fluid entering the kinetic reactor is forced through opposing orifices at opposite ends of the kinetic reactor creating impinging streams. The resulting collision of the streams causes high shear and cavitation to complete the reaction producing the biodiesel fuel. The opposing orifices are adjustable through the internal needle valve to provide the desired effect.

In accordance with yet another aspect of the invention, there is provided apparatus which may be embodied in a skid mounted integrated system for convenient installation at a biodiesel fuel production facility. The integrated system may be designed with flexibility to either retrofit into an existing biodiesel fuel production facility which previous used a conventional technology or be installed at a new biodiesel production facility. When feed pumps are already in place at the production facility, metering pumps included in the integrated system are bypassed and each ingredient is metered through control valves included in the integrated system. In a new facility, the ingredients may be metered through pumps included in the integrated system.

In accordance with yet another aspect of the invention, there is provided a method for producing biodiesel fuel from a mixture of feed oil, alcohol, and catalyst. The catalyst may be potassium methoxide, sodium methoxide, or sodium methylate and catalyst dosing is between 0.4% to 1.2% depending upon the type of catalyst used. The alcohol is preferably methanol and between fourteen and eighteen percent of the incoming feed oil. The method generally includes steps of providing feed oil to a mixer, providing alcohol to the mixer at step 202, providing catalyst to the mixer, mixing the feed oil, the alcohol, and the catalyst in the mixer to produce a mixture, providing the mixture to a packed column, pumping the mixture through the packed column to react the mixture to produce a partially reacted mixture, providing the partially reacted mixture to a high pressure kinetic reactor, and pumping through the high pressure kinetic reactor to complete the reaction to produce biodiesel fuel.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a high level diagram of a biodiesel fuel processing system according to the present invention.

FIG. 2 is a flow control valve assembly for the biodiesel fuel processing system.

FIG. 3 is a metering pump assembly for the biodiesel fuel processing system.

FIG. 4 is a high pressure kinetic reactor assembly according to the present invention.

FIG. 5 is a packed column of the biodiesel fuel processing system according to the present invention.

FIG. 6 is a high pressure cavitation reactor according to the present invention.

FIG. 7 is a nozzle of the high pressure cavitation reactor according to the present invention.

FIG. 8 is a cross-sectional view of the nozzle of the high pressure cavitation reactor taken along 8-8 of FIG. 7.

FIG. 9 is a side view of a static mixer of the biodiesel fuel processing system according to the present invention.

FIG. 10 is a perspective view of a mixing element of the static mixer of the biodiesel fuel processing system according to the present invention.

FIG. 11 is a method for biodiesel fuel production according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

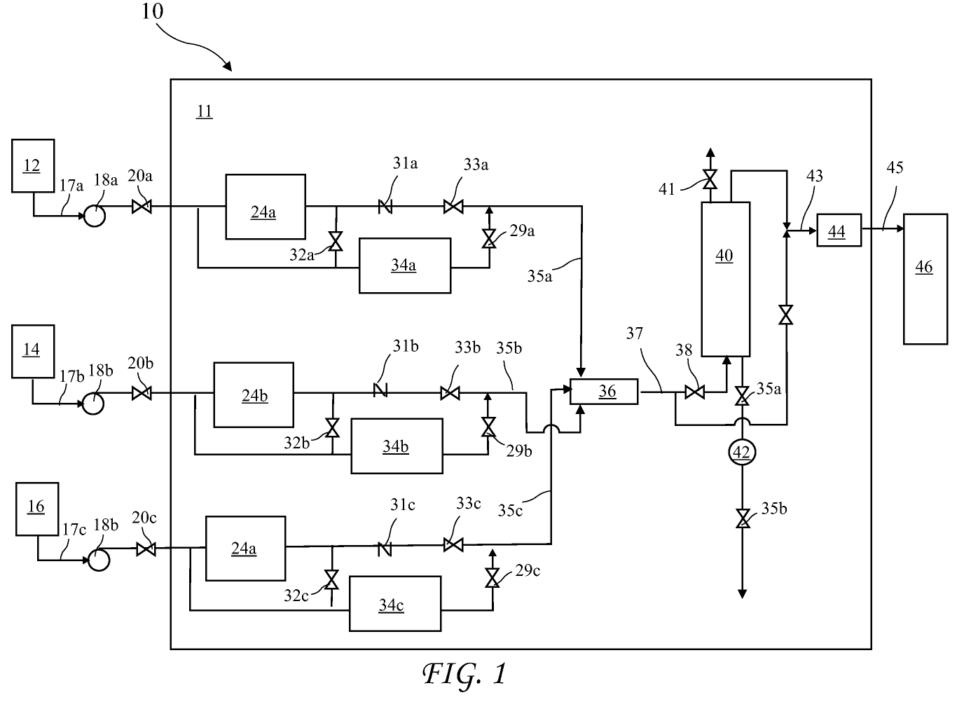

A high level diagram of a biodiesel fuel processing system 10 according to the present invention is shown in FIG. 1. The biodiesel fuel processing system 10 may be pre-assembled on a skid 11 for delivery to a biodiesel fuel production facility. The biodiesel fuel processing system 10 includes two sequential phases for biodiesel fuel production. The first phase is performed in a packed column 40 and the second phase is performed in a high pressure kinetic reactor assembly 44. Feed oil, alcohol, and a catalyst are combined and reacted to produce the biodiesel fuel. The biodiesel fuel production facility includes a catalyst tank 12, an alcohol tank 14, and a feed oil tank 16. The feed oil, alcohol, and catalyst are provided to the biodiesel fuel processing system 10 through a 1.5 inch diameter line 17c, a one inch diameter line 17b, and a ¾ inch diameter line 17a respectively, the lines sizes corresponding to flow rates and viscosity of the ingredients. The respective lines sizes are carried on through the biodiesel fuel processing system 10 to a point where the flows are mixed by a mixer 36. Each ingredient passes through a pump 18a, 18b, and 18c in the lines 17a, 17b, and 17c respectively, and is controllable through first valves 20a, 20b, and 20c respectively, the pumps 18a-18c, and the valves, 20a-20c reside off the skid.

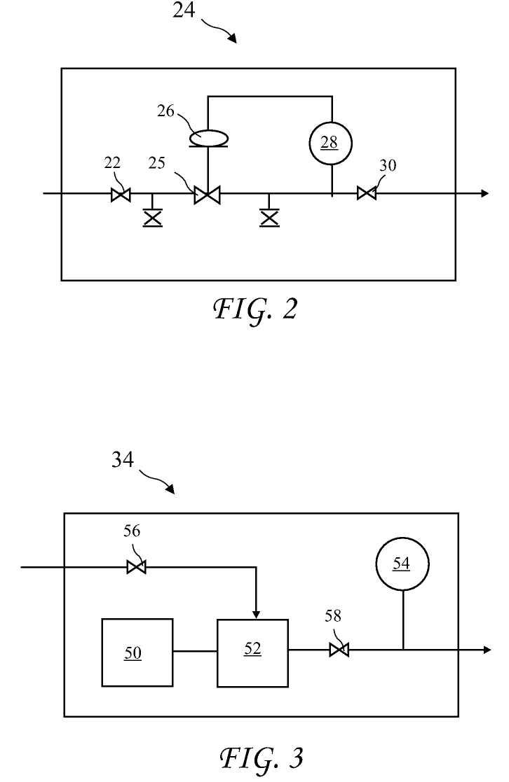

The biodiesel fuel processing system 10 is configured for installation at an existing biodiesel fuel production facility or at a newly constructed biodiesel fuel production facility. When the biodiesel fuel processing system 10 is installed in an existing biodiesel fuel production facility include existing pumps, the flows of ingredients are routed through flow control assemblies 24a-24c (see FIG. 2) to control the amounts of each ingredient. When the biodiesel fuel processing system 10 is installed in a new biodiesel fuel production facility, the flows of ingredients may be routed through metering pump assemblies 34a-34c (see FIG. 3) to control the amounts of each ingredient. After either of the flow control assemblies 24a-24c and the metering pump assemblies 34a-34c, metered flows 35a, 35b, and 35c are directed to a mixer 36. The flows of ingredients are controlled to provide between approximately 81 and 85 percent by volume feed oil, between approximately 14 and 18 percent by volume alcohol and between approximately 0.4 and 1.2 percent by volume catalyst. A suitable mixer 36 is a venturi static mixer. The preferred venturi static mixer not only mixes the three fluid streams into a homogenous phase, it also acts as a mini kinetic reactor, providing first phase of transesterification reaction

The flows through the flow control assemblies 24a pass through check valves 31a, 31b, and 31c and valves 33a, 33b, and 33c respectively to control the flow into the mixer 36. The flows from the metering pump assemblies 34a-34c pass through valves 29a, 29b, and 29c to control the flow into the mixer 36.

After mixing in the mixer 36, the mixed flow 37 passes through a third valve 38 and into the packed column 40 for a first phase of the reaction of the ingredients to form the biodiesel fuel. About 40 to 70 percent of the reaction generally occurs in the packed column 40. The partially reacted ingredients 43 flow from the packed column 40 to a high pressure kinetic reactor assembly 44 to complete the reaction of the ingredients into biodiesel fuel 45. The biodiesel fuel 45 flows into a biodiesel holding tank 46. The packed column 40 additionally includes a drain line with a valve 35a, a sight glass 42 and a valve 35b sequentially from the packed column 40, and a vent from the top of the packed column 40 through a valve 41.

The flow control assembly 24 for the biodiesel fuel processing system 10 is shown in FIG. 2. The flow control assembly 24 is used when the biodiesel fuel processing system 10 is installed in an existing biodiesel fuel production facility. A fourth valve 22 controls the flow into the flow control assembly 24 and a fifth valve 30 controls the flow from the flow control assembly 24. The flow through the flow control assembly 24 is regulated by a flow control valve 25 with an actuator 26 receiving a feedback signal from a flow controller 28. Each of the flow control assemblies 24a, 24b, and 24c is represented by the flow control assembly 24.

The metering pump assembly 34 for the biodiesel fuel processing system 10 is shown in FIG. 3. The metering pump assembly 34 includes a valve 56, a pump 52, a motor 50 driving the pump 52, and a pressure gauge 54 for monitoring the pressure of the flow through the metering pump assembly 34. A valve 58 controls the flow from the metering pump assembly 34. Each of the metering pump assemblies 34a, 34b, and 34c is represented by the metering pump assembly 24. The metering pumps in the metering pump assembly 34 are initially adjusted in the factory for fixed volume of flow according to the formulation needed for transesterification reaction, however, they can be field adjusted later to a desired formulation.

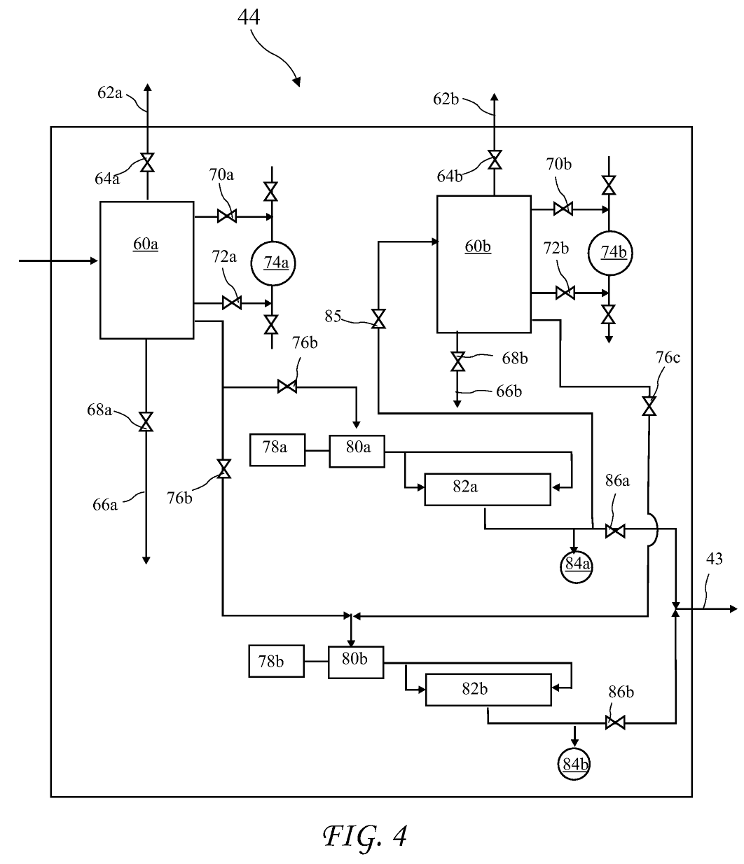

The high pressure kinetic reactor assembly 44 of the biodiesel fuel processing system 10 is shown in FIG. 4. A first surge tank 60 receives the partially reacted ingredients 43 from the packed column 40. Alternatively, the surge tank 60a may receive flow directly from the mixer 36 through line 37. The first surge tank 60a is designed for five minutes holding time to provide a uniform flow to high pressure pump 80a. A first level gauge 74a monitors the level of liquid in the first surge tank 60a. The first surge tank 60a is vented through valve 64a for methane recovery through line 62a and includes a drain line 66a through a valve 68a. The partially reacted ingredients are carried from the surge tank 60a to high pressure pump 80a through valve 76a or alternatively the partially reacted ingredients can go to high pressure pump 80b through valve 76b. The high pressure pumps 80a and 80b are driven by motors 78a and 78b respectively to provide the partially reacted ingredients to kinetic reactors 82a and 82b respectively where the reaction of the ingredients to form the biodiesel fuel is completed. Gauges 84a and 84b monitor the flows of the biodiesel fuel through valves 86a and 86b respectively to the biodiesel fuel tank 46. All of the main flows of ingredients to, through, and from the kinetic reactor assembly 44 are preferably through 1½ inch diameter lines.

A second surge tank 60b, also designed for five minutes holding time to provide uniform flow to high pressure pump 82b, is connected to the biodiesel fuel flow from the first reactor 82a through a valve 85. The surge tank 60b is further connected to the inlet of the high pressure pump 82b through a valve 76c. Alternatively, the flow from surge tank 69b can go directly to high pressure pump 80a through valve 76b. Surge tanks 60a and 60b are further connected to level gauges 74a and 74b respectively at high positions on the surge tanks 60a and 60b through valves 70a and 70b, and at low positions on the surge tanks 60a and 60b through valves 72a and 72b. The second surge tank 60b is vented through valve 64b for methane recovery through line 62b and includes a drain line 66b through a valve 68b.

The packed column 40 is shown in detail in FIG. 5. The packed column 40 is packed with rings 90 (for example, either Raschig rings or pall rings or equivalent). The homogeneous stream enters from the bottom resulting in the rings 90 being in a fluidized bed state. The fluidized bed state provides the advantage of low pressure drop and no channeling effect (fluid bypasses the rings in channeling) which affords good contact surface for reaction to take place uniformly. The packed column 40 preferably comprises three packed columns in series, each packed column approximately eight inches in diameter and approximately sixty inches high. Approximately 40-70 percent of the reaction of the ingredients is generally achieved in the packed column 40.

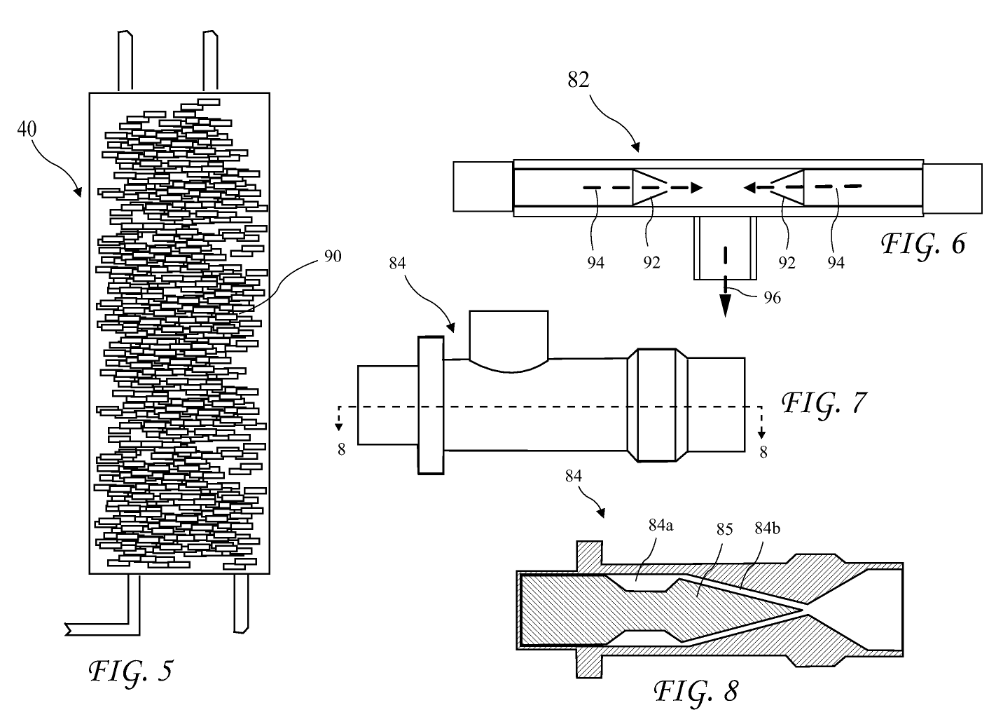

A high pressure kinetic reactor 82 suitable for use as either the kinetic reactor 82a or 82b in the high pressure kinetic reactor assembly 44 is shown in FIG. 6. The kinetic reactor 82 is based on principles of hydro cavitation whereby the cavitation forces break fluid molecules into nano molecules with very high instantaneous temperatures and availability of large surface areas which allow complete reaction without external heat. The kinetic reactor 82 splits the partially reacted flow from the packed column 40 into two flows and impinges the two flows on each other from opposite directions to complete the reaction of the ingredients producing the biodiesel fuel. The kinetic reactor is based on principles of hydro cavitation and high shearing whereby the cavitation and shearing forces break fluid molecules into nano molecules with very high instantaneous temperatures and availability of large surface areas which allow complete reaction without external heat. A suitable kinetic reactor is a high pressure cavitation chamber.

The kinetic reactor 82b also is thus equipped with impingement technology whereby two streams collide with each other causing additional contact for complete reaction of the ingredients into biodiesel fuel and the byproduct glycerine. The high pressure kinetic reactor is operated at 900-1,000 psi pressure and is composed of adjustable need valve design in 82a where fluid entering is reactor is forced out through an orifice which is adjustable through internal needle valve, causing high shear and cavitation and a split orifice design in 82b where fluid is first forced through two identical split orifices at each end of the reactor, causing high shear and cavitation and then the two streams impinge on each other from opposite direction to complete the reaction producing the biodiesel fuel. While a high pressure cavitation chamber is described above, biodiesel fuel production systems including other kinetic reactors operating on the principles of hydro cavitation are intended to come within the scope of the present invention.

A nozzle 84 of the kinetic reactor 82 according to the present invention is shown in FIG. 7 and a cross-sectional view of the nozzle 84 taken along 8-8 of FIG. 7 is shown in FIG. 8. A flow shaping cone (or needle valve) 85 resides in the nozzle 84 and forms a nozzle cavity 84a and a conical flow accelerator (or high pressure orifice) 84b between the flow shaping cone 86 and the interior of the nozzle 84. The nozzle 84 receives a flow of partially reacted ingredients into the nozzle cavity 84a and the flow accelerates through the conical flow accelerator 84b and is directed against an opposing similarly formed flow to provide the hydro cavitation.

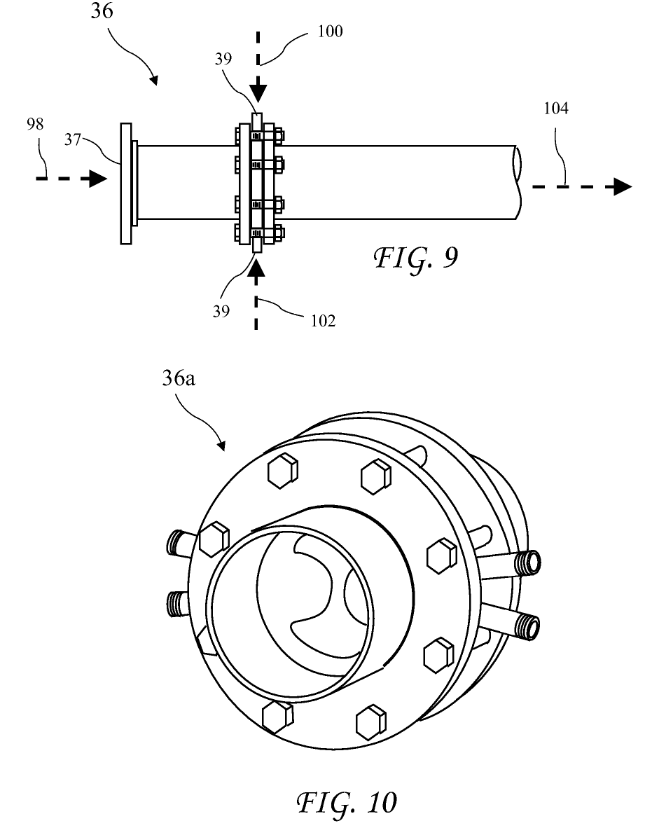

A side view of a static mixer 36 of the biodiesel fuel processing system is shown in FIG. 9 and a perspective view of a mixing element 36a of the static mixer 36 is shown in FIG. 10. The static mixer 36 receives the feed oil flow 98 into a mixer mouth 37 and the alcohol flow 100 and catalyst flow 102 into side ports 39.

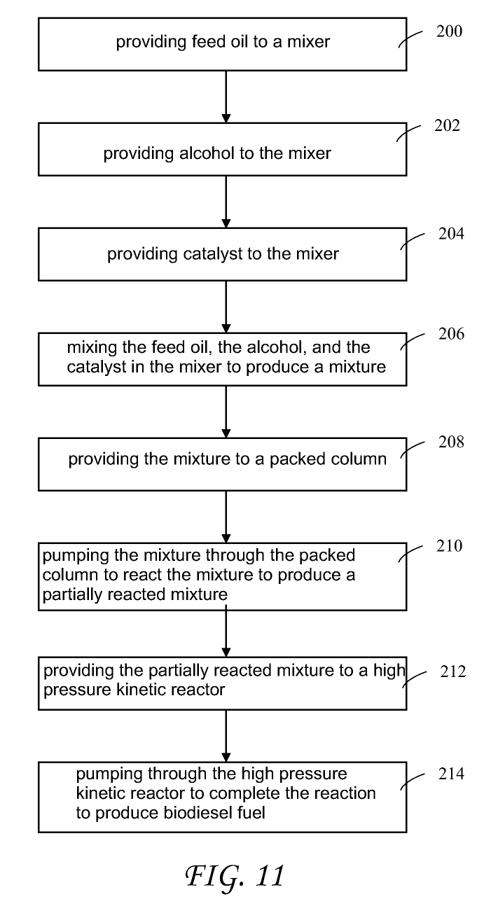

A method for rapidly producing biodiesel fuel according to the present invention is described in FIG. 11. The method includes providing feed oil to a mixer at step 200, providing alcohol to the mixer at step 202, providing catalyst to the mixer at step 204, mixing the feed oil, the alcohol, and the catalyst in the mixer to produce a mixture at step 206, providing the mixture to a packed column at step 208, pumping the mixture through the packed column to react the mixture to produce a partially reacted mixture at step 210, providing the partially reacted mixture to a high pressure kinetic reactor at step 212, and pumping through the high pressure kinetic reactor to complete the reaction to produce biodiesel fuel at step 214. The method may further more particularly includes steps described above.

Various valves which are not described herein in detail are provided for functions related to installation, filling, purging, etc. which will be obvious to those skilled in the art.

While the invention herein disclosed has been described by means of specific embodiments and applications thereof, numerous modifications and variations could be made thereto by those skilled in the art without departing from the scope of the invention set forth in the claims.

I claim:

1. Apparatus for rapid production of biodiesel fuel, the apparatus comprising:
a source of ingredients comprising:
a source of feed oil;
a source of alcohol; and
a source of catalyst;
a venturi mixer in fluid communication with the sources of the feed oil, the alcohol, and the catalyst for mixing the feed oil, the alcohol, and the catalyst into a mixture of ingredients;
a packed column in fluid communication with the venturi mixer for receiving the mixture for providing partially reacted flow from the mixture of ingredients; and
a high pressure kinetic reactor in fluid communication with the packed column for receiving the partially reacted mixture, for completing the reaction of the partially reacted flow to provide the biodiesel fuel, the kinetic reactor including nozzles for directing impinging split flows of the partially reacted mixture.

2. The Apparatus of claim 1, wherein the packed column comprises three packed columns in series.

3. The Apparatus of claim 2, wherein the packed column comprises three packed columns in series, each packed column approximately eight inches in diameter and approximately sixty inches high.

4. The Apparatus of claim 1, wherein the source of alcohol is a source of methanol.

5. The Apparatus of claim 1, wherein the source of catalyst is a source of catalyst selected from the group consisting of potassium methoxide, sodium methoxide, and sodium methylate.

6. The Apparatus of claim 1, further including a flow control assembly between each source of ingredients and the mixer.

7. The Apparatus of claim 1, further including a metering pump assembly between each source of ingredients and the mixer.

8. The Apparatus of claim 1, wherein the mixed flow of ingredients is between approximately 81 and 85 percent by volume feed oil, between approximately 14 and 18 percent by volume alcohol and between approximately 0.4 and 1.2 percent by volume catalyst.

9. The Apparatus of claim 1, wherein the high pressure kinetic reactor operates on the principles of hydro cavitation.

10. The Apparatus of claim 9, wherein the high pressure kinetic reactor creates cavitation forces to break fluid molecules into nano molecules with very high instantaneous temperatures and availability of large surface areas to provide complete reaction without external heat.

11. The Apparatus of claim 1, wherein the high pressure kinetic reactor comprises a high pressure cavitation chamber.

12. The Apparatus of claim 1, wherein the high pressure kinetic reactor includes flow accelerators at opposite ends of the high pressure kinetic reactor, the flow accelerators creating high velocity impinging flows of the partially reacted ingredients to complete the reaction.

13. The Apparatus of claim 1, wherein the packed column comprises three packed columns in series.

14. The Apparatus of claim 13, wherein the packed column comprises three packed columns, each approximately eight inches in diameter and approximately sixty inches high.

15. The Apparatus of claim 1, wherein the packed column is filled with Raschig rings.

16. The Apparatus of claim 1, wherein the packed column is filled with pall rings.

17. Apparatus for rapid production of biodiesel fuel, the apparatus comprising:
A source of ingredients comprising:
a source of feed oil;
a source of methanol; and
a source of catalyst selected from the group consisting of a source of potassium methoxide, a source of sodium methoxide, a source of sodium methylate;
one selected from the group consisting of a flow control assembly and a metering pump assembly controlling flows of the ingredients to provide flows of between approximately 81 and 85 percent by volume feed oil, between approximately 14 and 18 percent by volume alcohol and between approximately 0.4 and 1.2 percent by volume catalyst;
a venturi mixer in fluid communication with the controlled flows of the feed oil, the alcohol, and the catalyst for mixing the feed oil, the alcohol, and the catalyst into a mixture of ingredients;
a packed column in fluid communication with the venturi mixer for receiving the mixture for providing partially reacted flow from the mixture of ingredients; and
a high pressure kinetic reactor including opposing adjustable need valve accelerators at opposite ends of the high pressure kinetic reactor, the flow accelerators creating high velocity impinging flows of the partially reacted ingredients to complete the reaction, the high pressure kinetic reactor operated at between 900 and 1,000 psi pressure in fluid communication with the packed column for receiving the partially reacted mixture, for completing the reaction of the partially reacted flow to provide the biodiesel fuel, the kinetic reactor including nozzles for directing impinging split flows of the partially reacted mixture.

18. A method for rapid production of biodiesel fuel, the method comprising:
providing feed oil to a mixer;
providing alcohol to the mixer;
providing catalyst to the mixer;
mixing the feed oil, the alcohol, and the catalyst in the mixer to produce a mixture;
providing the mixture to a packed column;
pumping the mixture through the packed column to react the mixture to produce a partially reacted mixture;
providing the partially reacted mixture to a high pressure kinetic reactor; and
pumping through the high pressure kinetic reactor to complete the reaction to produce biodiesel fuel.
